(19) United States
(12) Patent Application Publication
(10) Pub. No.: US 2009/0094048 A1
(43) Pub. Date: Apr. 9, 2009

(54) System and Method For Facilitating The Introduction of Compatible Individuals Using Third Party Collaborative Tools

(75) Inventors: Karen Wallace, San Francisco, CA (US); Suneet Wadhwa, San Francisco, CA (US); Andrew Pickholtz, San Francisco, CA (US)

Correspondence Address: NOVAK DRUCE DELUCA + QUIGG LLP, 1300 EYE STREET NW, SUITE 1000 WEST TOWER, WASHINGTON, DC, 20005, US

(73) Assignee: ENGAGE CORPORATION, San Mateo, CA (US)

(21) Appl. No.: 12/098,983

(22) Filed: Apr. 7, 2008

Related U.S. Application Data
(63) Continuation-in-part of application No. 11/425,390, filed on Jun. 20, 2006.
(60) Provisional application No. 60/595,282, filed on Jun. 20, 2005.

(51) Int. Cl. G06Q 99/00

(52) U.S. Cl. 705/1

(57) ABSTRACT

A system and method for facilitating an online collaborative community for individuals to meet each other, make suggestions to members in their network of other individuals as potential matches, and introduce members to each other. A number of features are provided that promote collaboration among members of the online community with regard to suggested matches of potentially compatible individuals. A first feature enables a user to initiate a multi-party discussion concerning suggested matches for particular individuals. The user has the ability to attach a profile of the suggested match to the discussion, which may be retrieved and viewed by the invited parties to the discussion. Invited parties may be non-members as well as members of the online community. A “social feed” is provided to a user to inform the user of activities happening on the site that are related to the user or any friends to whom he/she is connected. A points system is provided to award points to users for participation in various categories of activities and actions that promote the advancement of the introduction and matching network. Various games modules are provided to encourage matchmaking activities by enhancing the entertainment value of site participation. A scoreboard is also provided, which lists the top-scoring users of the site.

### CROSS-REFERENCE TO RELATED APPLICATIONS

This application is a continuation-in-part, under 35 U.S.C. § 120, of co-pending application Ser. No. 11/425,390 filed Jun. 20, 2006, which claimed the benefit and priority, under 35 U.S.C. § 119(e), of U.S. Provisional Patent Application No. 60/595,282, filed Jun. 20, 2005 and entitled “System and Method for Facilitating Matching of Compatible Individuals,” which applications are hereby incorporated by reference in their entireties.

### FIELD OF THE INVENTION

The invention generally relates to the field of computerized methods of and systems for matching compatible individuals for romantic and other social, cultural, special interest and/or business purposes. The invention also relates generally to the field of computerized methods of and systems for organizing networks of individuals in online communities for social or professional purposes. More particularly, the invention relates to methods and systems for enabling the involvement of third party intermediaries or matchmakers in the processes of identifying potentially compatible individuals and arranging for the introduction of those individuals to each other. The invention facilitates the collaboration of third parties in the identification of potentially compatible individuals and the introduction of people by people.

### BACKGROUND OF THE INVENTION

### Related Art

Currently, a variety of services are commercially available to assist an individual in finding a suitable match for companionship or other purposes. Such services include proprietary databases for use by professional matchmakers, membership-based online dating services, and online social networking services.

Professional matchmakers and matchmaking services typically interview new clients to gather information about the clients that will be useful in the matchmaking process. The profile information usually includes such characteristics as a client's age, height, weight, religion, educational level, profession, income, and hobbies. In addition, clients often provide a photograph or video of themselves. At the same time, the client specifies the characteristics they desire in a mate. For example, the client might identify an age range, and acceptable religions and ethnicities, among other things, for what they consider to be a suitable mate or partner.

For years, professional matchmakers and matchmaking services have relied on proprietary computerized databases to store the data provided by and about their clients. The matchmaker could then search their databases to identify suitable matching clients to introduce to each other. Additionally, computerized matching algorithms could assist the matchmakers identify suitable matches.

With the advent of widespread availability and use of the World Wide Web (“Web”) on the Internet during the 1990s, a new type of computerized dating service gained in popularity. Indeed, these online dating sites are still gaining in popularity. Examples of such sites are the current versions of www.match.com, www.matchmaker.com and Yahoo! Personals. Online dating sites allow users themselves to enter their own personal information into the site's database. The sites usually also allow users to upload one or more photos and sometimes video or audio of the user. The user providing this information then becomes a member of the site, sometimes paying a fee for certain services and sometimes not, depending on the service and any promotions being run by the site at that time.

When other users or guests visit the member-based dating Web site, the user or guest can typically search the database of existing members based on desirable personal characteristics. Such characteristics include age range, geographic location, religion, etc. If a search reveals a suitable individual, the user or guest can contact the member via electronic mail (“e-mail”) to arrange a conversation or meeting.

Some member-based dating Web sites include computerized recommendation engines that rely on mathematical algorithms to assist in the selection of suitably compatible matches. Web sites that use more sophisticated algorithms for such purposes often request additional information of the members, such as asking the members to answer questions that are expected to be revealing of the member's personality. An example of such a Web site is the current version of www.eharmony.com.

Another type of Web site that has somewhat different objectives and operation than an online dating service is an online social networking service. Online social networking services permit members to build groups of other members into networks of friends or associates. Each member can invite other people to participate on the service in the member's network. Depending on the service, a member can look at, search for and contact members that they invited, and members who were directly or indirectly invited by their invitees. Sometimes the purpose of the network is explicitly stated and invitations are oriented towards that purpose. For example, the current version of www.linkedin.com states that the networks can be useful for finding clients, sales leads, jobs and services. The current version of www.friendster.com states that the network is useful to stay connected with friends.

Existing matchmaking services have numerous shortcomings. Proprietary databases used by professional matchmakers do not benefit from the interactive nature of self-service Web applications or their efficiencies. Potential daters have to rely exclusively on the judgment of a single or small number of matchmakers to cull through the available matches.

Existing member-based dating Web sites have their own deficiencies. First, members, particularly attractive women, are often barraged by numerous requests for a conversation or date. Consequently, many requests to meet both promising and unlikely matches are often ignored. Second, the fact that many emails between members are unanswered results in a feeling of rejection or alienation for other members, particularly shy men. Third, members, especially women, are often fearful of conversing with or meeting other members they meet online since there is little or no way to know whether the other member can be trusted. Fourth, particularly because of the high rejection rate for inter-member communication, existing services tend to be isolating, resulting in a perceived social stigma for participants. Fifth, the high rejection rates and tendency towards individual isolation inherent in the services contribute to a higher rate of “churn.” Many members discontinue their membership with the services even before successfully finding a long-term romantic partner. Sixth, existing services do not cater to married users and others who enjoy assisting others with their love lives or watching and gossiping about other people's love lives. Seventh, existing services are not particularly fun to use.

Similarly, existing social networking sites are not well suited for meeting romantic companions. On these sites, a member's network only includes people the member knows directly or indirectly. This imposes an undesirable limitation on the number of persons the member might correspond with and meet for purposes of dating. This limitation undermines one of the advantages of self-service Web sites for dating: the potentially large population of possible suitors.

Another disadvantage of social networking sites for dating is that the purpose of the invitations may be only obliquely related to dating. Since the purpose of the network is for building a large community, e.g. of professional colleagues or friends, the concept of the network itself has limited added value for romantic purposes. Indeed, the network may be a disadvantage for daters, since, just as in the offline world, there are social and professional risks in asking existing friends and colleagues for a date, even if the friendship or professional relationship is indirect.

Another disadvantage of many existing social networking sites is that users are not usually willing to pay for the type of service that they provide. In particular, users are not generally interested in paying for friendship, tracking friends or voyeuristically looking at lists of friends of friends.

Consequently, what is needed is an online service that addresses the shortcomings of the existing member-based dating sites and social networking sites for purposes of dating and romance.

### SUMMARY OF THE INVENTION

The present invention provides a system and method for facilitating an online collaborative community for individuals to meet each other with the assistance of third party intermediaries or matchmakers. The system provides the intermediaries with a variety of features to participate and collaborate in the process of identifying potentially compatible individuals and arranging for the introduction of those individuals to each other. For example, the intermediaries can provide profile information about individual participants, search for potentially compatible individuals for others, or introduce individuals to each other. The intermediaries making the introductions may be professional matchmakers, amateur matchmakers, friends of participants, or casual users. The introductions can be of individuals who are already participating in the online community or who are subsequently invited to participate.

In particular, the present invention provides a number of features that promote collaboration among members of the online community with regard to suggested matches of potentially compatible individuals. A first feature enables a user to initiate a multi-party discussion concerning suggested matches for particular individuals. The user has the ability to attach a profile of the suggested match to the discussion, which may be retrieved and viewed by the invited parties to the discussion. Invited parties may be non-members as well as members of the online community.

According to another aspect of the invention, a “social feed” is provided to a user to inform the user of activities happening on the site that are related to the user or any friends to whom he/she is connected.

In accordance with another aspect of the invention, a points system is provided to award points to users for participation in various categories of activities and actions that promote the advancement of the introduction and matching network.

In accordance with yet another aspect of the invention, various games modules are provided to encourage matchmaking activities by enhancing the entertainment value of site participation. A scoreboard is also provided, which lists the top-scoring users of the site.

Still other features of the system are described herein. By providing facilities to make it easy and fun to be a matchmaker, the system benefits daters and matchmakers alike.

### BRIEF DESCRIPTION OF THE DRAWINGS

The invention is described in detail with reference to the following figures, in which:

FIG. 1 is a diagram of a home page in accordance with an embodiment of the present invention, wherein multiple “conveyor-belts” of user profiles are displayed by categories;

FIG. 2 shows an example of the invention wherein a user may directly indicate interest in a suggested profile for the user;

FIG. 3 shows an example of the invention wherein a user may indicate a profile suggestion for a friend of the user;

FIG. 4 shows an example of awarding social points to a user for making a match suggestion in accordance with the invention;

FIG. 5 shows an example of the capability of a user to suggest a profile as a match for another user, or non-member, or him/herself, and to send the suggestion to a friend;

FIG. 6 shows an example of a “social feed” information box for providing information to a user about events and occurrences on the site;

FIG. 7 shows an example of a “meet-match” page in which a user may view profiles of potential matches and profiles of suggested matches for a friend of the user, where the user may make new suggestions and vote on existing suggestions, as well as view a comparative scoreboard for the friend;

FIG. 8 shows an example of a page in which a user may view suggestions made by a specific friend, and may make comments thereon, as well as view a comparative scoreboard for the friend;

FIG. 9 shows an example of a “fix-up” page where a user may converse with friends about a potential match for the user, view the profile of the potential match, and view voting results for the potential match;

FIG. 10 shows an example of a “fix-up” page where a user may converse with friends about a potential match for a friend of the user, view the profile of the potential match, and view voting results for the potential match;

FIG. 11 shows an example of a “social points” scoreboard;

FIG. 12 shows an example of a “Cast Your Vote” page in which a user may vote for one of a number of suggested potential matches for a friend;

FIG. 13 shows an example of displaying results of a “Cast Your Vote” poll;

FIG. 14 shows an example of a profile preview window in response to a pointer “rollover” on a user's photo;

FIG. 15 shows an example of a conversations page, which lists ongoing conversations among members, or members and non-members, of the site community;

FIG. 16 shows an example of a conversations page, from which a user may initiate a conversation with other members, friends, and non-members of the site community; and

FIG. 17 shows an example of a conversations page expanding a conversation from the list, wherein all posts to the conversation may be viewed.

### DETAILED DESCRIPTION OF THE INVENTION

The system may and generally would include features typical of traditional membership-based dating services, e.g. a registration process and a method to search through the database for members meeting certain criteria. However, more importantly, the system includes a variety of novel features oriented to matchmaking and collaborative introductions that embody different aspects of the invention. The features can be included in the service either individually or collectively with one or more of the other features. The system can charge users to access some of the services on the system, but not others. For example, a user wishing to meet other people and be introduced to other people for dating and other purposes may be charged a fee, while users registered only as matchmakers may be registered for free. In accordance with another aspect of the invention, a user who subscribes to the system as a paid member can be allowed to designate a predetermined plurality of additional individuals as members of the system, who would be included under the paid member's subscription. This feature fosters the virality of the online community and also builds stronger bonds between members of the community.

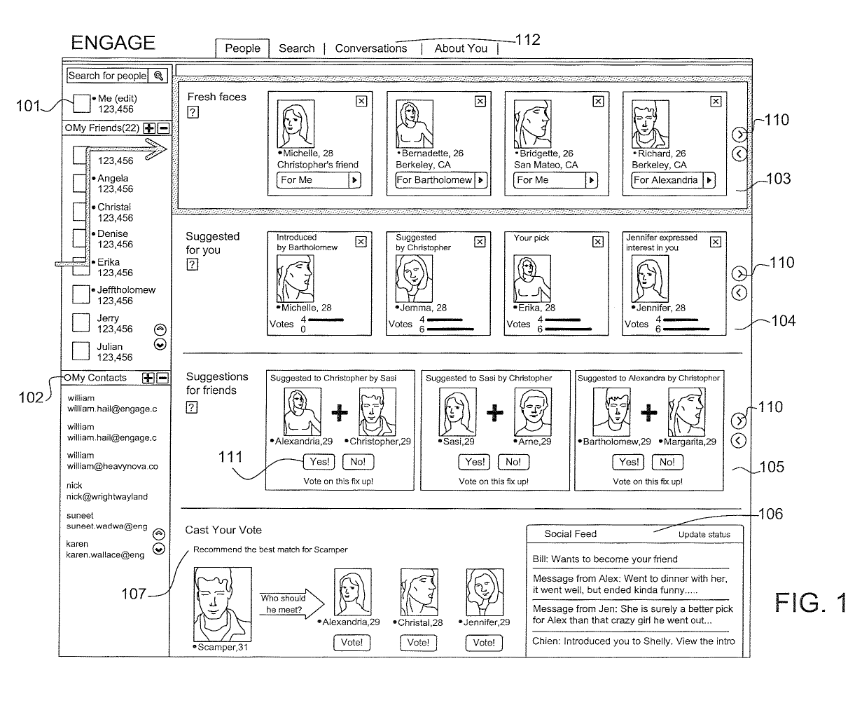

The service relies on the collaborative efforts of intermediaries or matchmakers to foment an online community with individuals seeking mates for romantic, business or other purposes. The service presents information to a user to facilitate the collaborative and community aspects of the service. In particular, as shown in FIG. 1, a user's log-in home page, accessible after the user has been signed-in, includes a number of areas that are personalized to the user. For example, “My Friends” area 101 includes a thumbnail listing of the user's friends who are also members of the online site (hereinafter referred to as “member friends”). The listing may include thumbnails photos of the user's member friends, together with the friend's name, and accumulated “social points” (which are points awarded to each user for participation in various activities and events on the site). The user may click or roll on the thumbnail photo and be presented with a profile of the member friend.

Additionally, the user's home page may provide a “My Contacts” area 102 that lists non-member friends and acquaintances of the user, as a convenience to the user but also for facilitating user communication with non-member friends through the site as a mechanism to encourage others to register as members of the site.

A number of different “conveyor” displays are provided on the user's home page. A “Fresh Faces” display 103 presents to the user members who are suggested as matches either for the user (identified as “For Me”) or for member friends of the user (identified as “For (Name of Friend)”). These suggestions can be chosen for presentation to the user based on various criteria, such as the user's list of friends and their profiles, the user's profile, members in the user's local region, age preference, religious preference, etc. Arrows 110 allow the user to shift the conveyor display to the right or left so as to display the next group of member profiles.

“Suggested For You” display 104 presents to the user members who have been suggested as potential matches for the user, and “Suggestions for Friends” display 105 presents to the user suggestions of matches between couples made by others. The user may vote on these suggestions by clicking on a “yes” or “no” voting button 111. The displayed suggestions may be suggestions made by a member friend of the user to another member (friend or non-friend of the user); suggestions made to another member for a friend of the user by another member (friend or non-friend of the user); or suggestions made directly to a friend of the user by another member (friend or non-friend of the user).

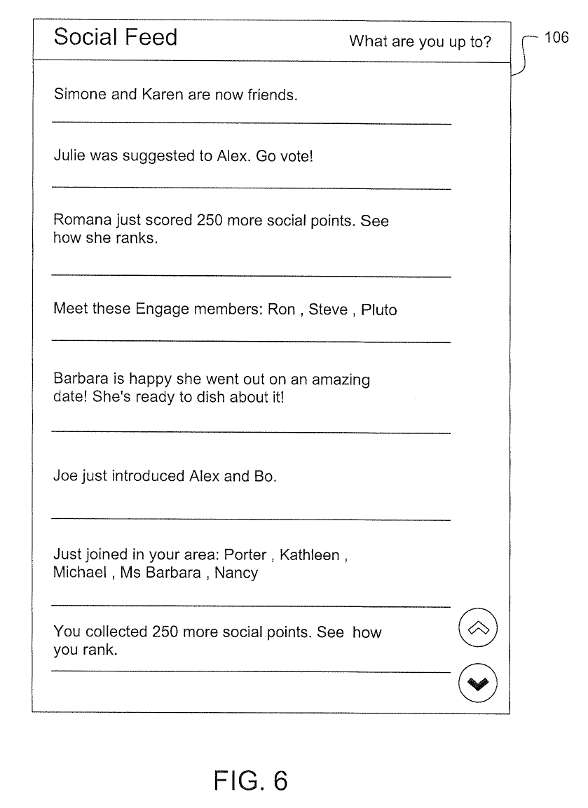

“Social Feed” area 106 presents a news feed or headline ticker display to the user, displaying various items of information concerning events or occurrences on the site, and incoming messages for the user. As shown in FIG. 6, the Social Feed presents items of information such as news of members who have been successfully introduced to each other, new suggestions for members, identification of newly registered members, news of members scoring social points, availability of a member's “dish” or recap of a recent date, etc. The user is able to navigate to each item of information by clicking on the respective headline item. The social feed also can be “pushed” to members via a daily e-mail.

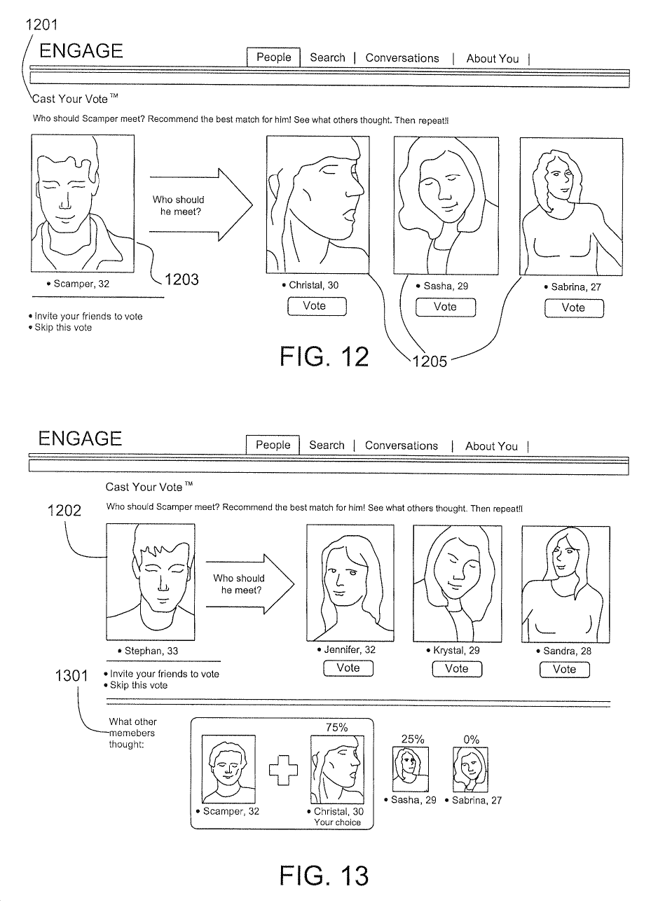

“Cast Your Vote” area 107 is an example of a game module, which presents to the user an activity for entertainment value, such as the ability to vote for a particular recommendation from a list of potential matches for a particular individual. Upon voting, the user may be presented with the latest voting tally, enabling the user to see how his/her vote compares with all others who have voted on those suggestions. The user may be awarded social points for participating in such activities. This feature is discussed in more detail below with reference to FIGS. 12 and 13.

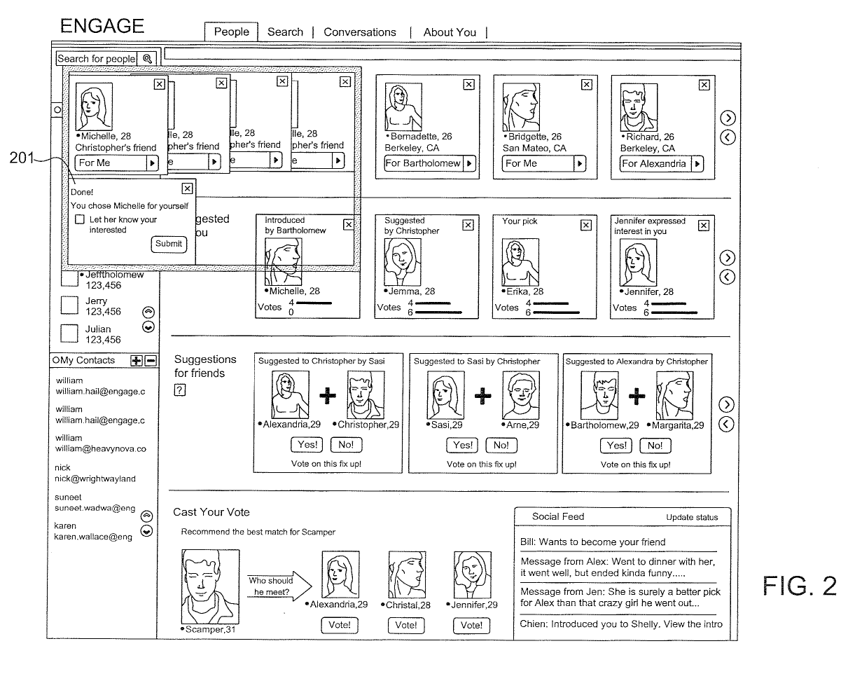

FIG. 2 illustrates an example in which a user wishes to express interest in a match suggestion made for the user from the “Fresh Faces” display 103. The user can click on a button or on the thumbnail photo of the suggestion to indicate interest, such that a window 201 will be presented, acknowledging the user's expression of interest. The user may instruct that a message be sent to the suggested match to inform her/him of the user's expression of interest.

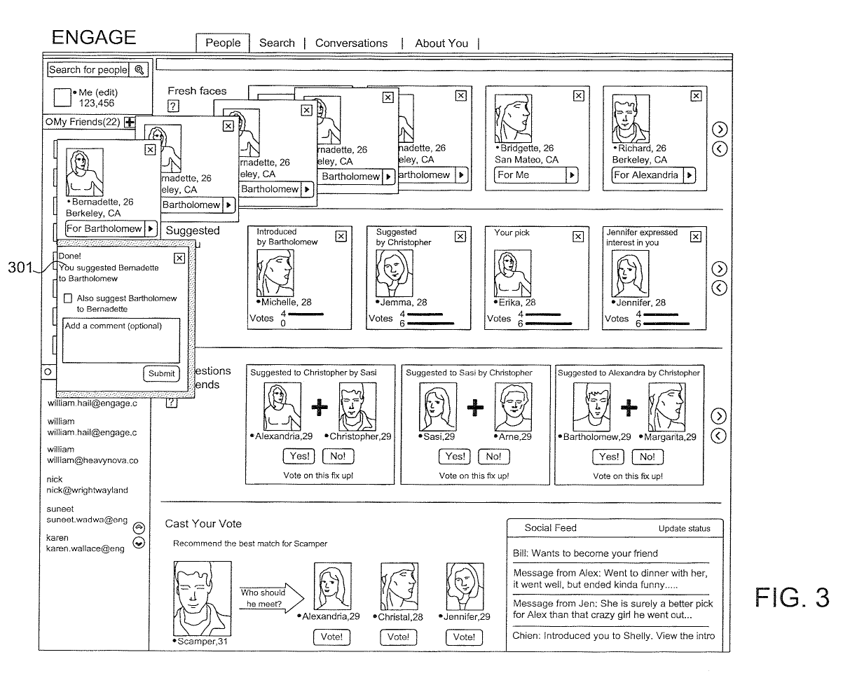

FIG. 3 illustrates an example in which a user makes a match suggestion to a friend from the “Fresh Faces” display 103. The user can click on a button or on the thumbnail photo of the suggested member to send the suggestion to the user's friend, such that a window 301 will be presented, acknowledging the user's suggestion. The user may also instruct that a message be sent to the suggested member to also suggest the user's friend to the suggested member.

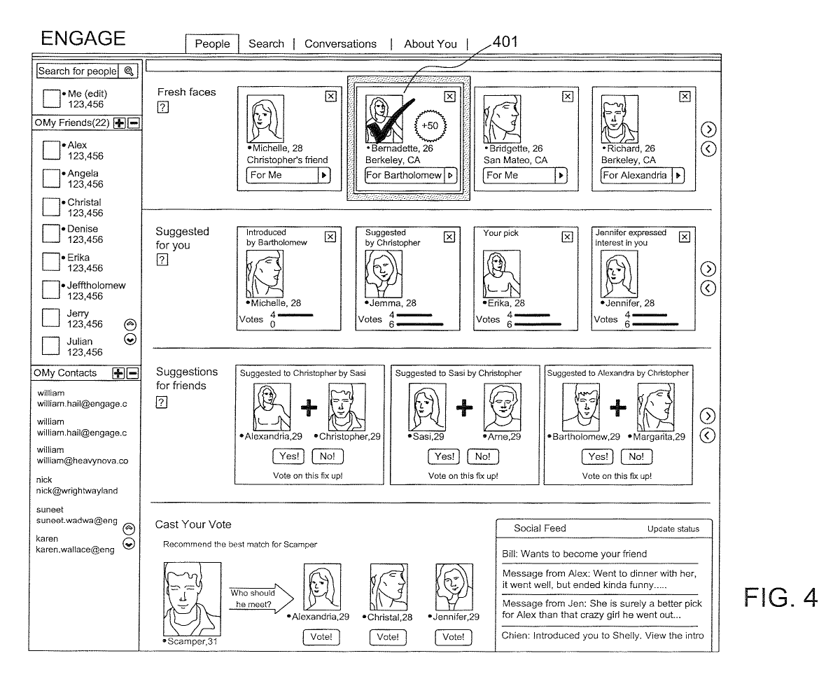

FIG. 4 illustrates an example of awarding social points to the user for having made a match suggestion. A points award 401 is displayed as a check mark or other symbol, together with the number of points being awarded, as a result of the user having made a suggestion of a member to the user's friend.

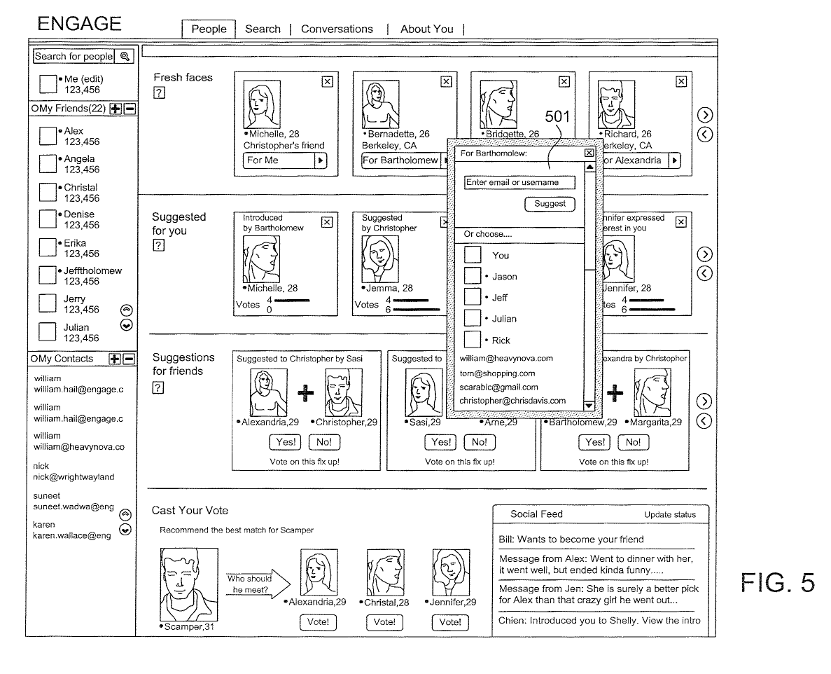

FIG. 5 illustrates an example of a suggestion window 501, which a user may call up by clicking on a member's profile, such as in the “Fresh Faces” display. The user may suggest the profile to one of the user's member friends, or non-member friends. This feature enables a user to make a quick suggestion of any member to anyone of the user's choosing, by quickly accessing a suggestion box 501. The box 501 will display a list of the user's friends (members and non-members) from which the user can easily designate the person to whom the suggestion is being made, either by clicking on the name/e-mail address of someone already in the user's list, or by entering the e-mail address or user name of a person not yet in the user's list.

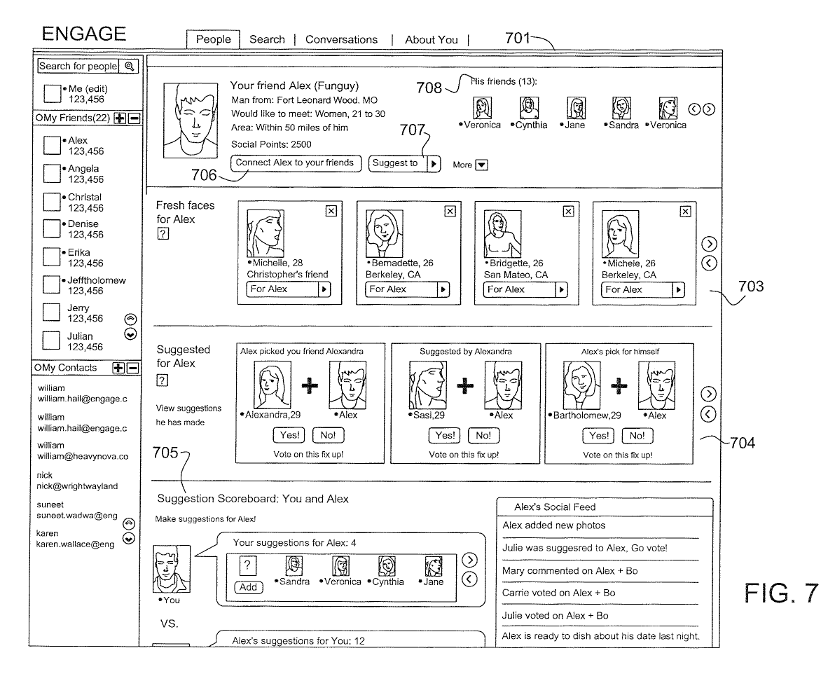

FIG. 7 illustrates an example of a member friend's “meet-match” page displayed to a user. The “meet-match” friend's page 701 is similar to the user's home page, in that it contains a “Fresh Faces” area 703 and a “Suggestions” area 704. This page also contains a thumbnail list of the “fix-up” friend's friends 708. A “connect” link 706 enables the user to introduce the “fix-up” friend to the user's list of friends, via e-mail communication, messages sent through the site, or other mode of communication. A “suggest to” link 707 enables the user to suggest the “fix-up” friend as a potential match to another member of the site. A “suggestion” scoreboard 705 keeps track of the number of suggested matches made by the user and the user's “fix-up” friend and may display the suggestions made, as a mechanism for encouraging active participation in the site.

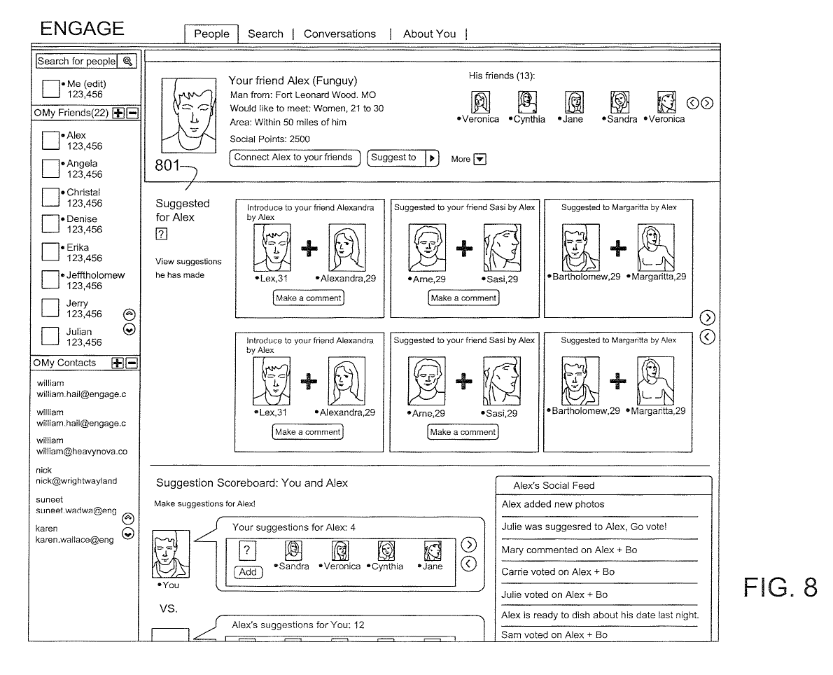

FIG. 8 illustrates an example of a display of activities of the user's “meet-match” friend which the user is able to view. For example, the suggestions made by the user's “meet-match” friend to other members may be shown in a conveyor-type display 801. The user may click on a “comment” button to add comments to the suggestions, which would be communicated to the parties privy to the suggestion.

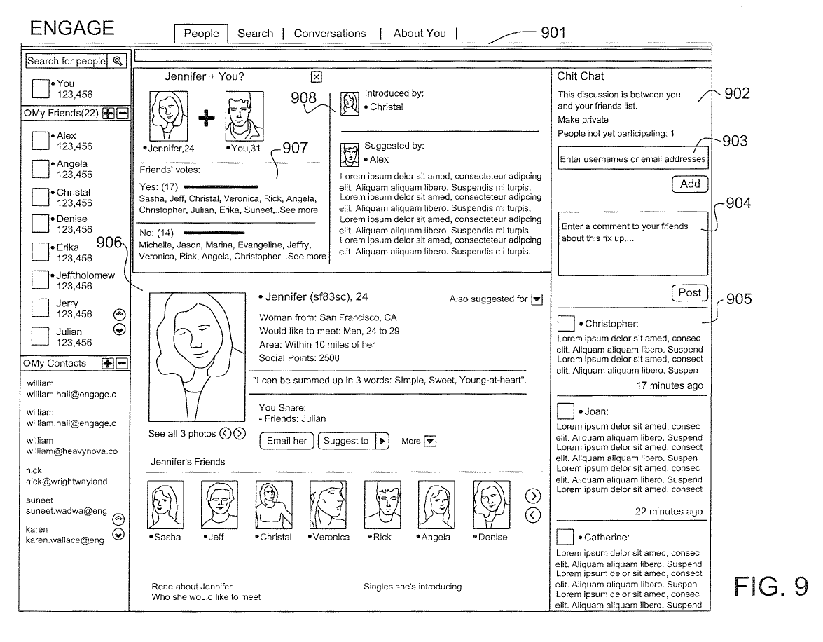

FIG. 9 shows a first example of a page directed to a proposed match between two members. In FIG. 9, page 901 pertains to a suggested match between the user and another member. The page contains various pieces of information concerning the proposed match, including: an area 908 showing the identity of the member or members who introduced the parties to each other, or who suggested the parties as a potential match, along with any comments; the profile 906 of the suggested member; a discussion area 902 in which the user may conduct an ongoing discussion regarding the suggested match; and a vote tabulation area 907 in which the user may view the results of friends' votes on the suggested match. A recipient data entry box 903 is provided wherein the user may enter the e-mail address or user name of parties with whom the user wishes to participate in the discussion. A text entry box 904 is provided wherein the user may enter comments relating to the ongoing discussion. Existing comments relating to the discussion are displayed in conversation area 905.

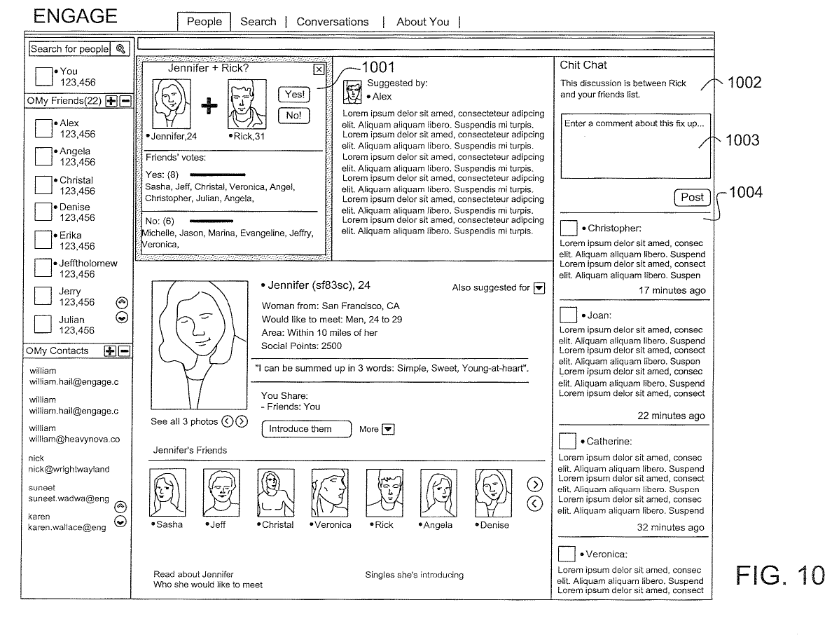

FIG. 10 shows a second example of a page 1001 directed to a proposed match between two members, wherein the suggested match is between a friend of the user and another member, or two friends of the user. In this case, the user would have been invited to participate in the conversation by another member. As such, the conversation area 1002 contains only a text entry area 1003 and running conversation area 1004, as the user is not allowed to add participants in this context.

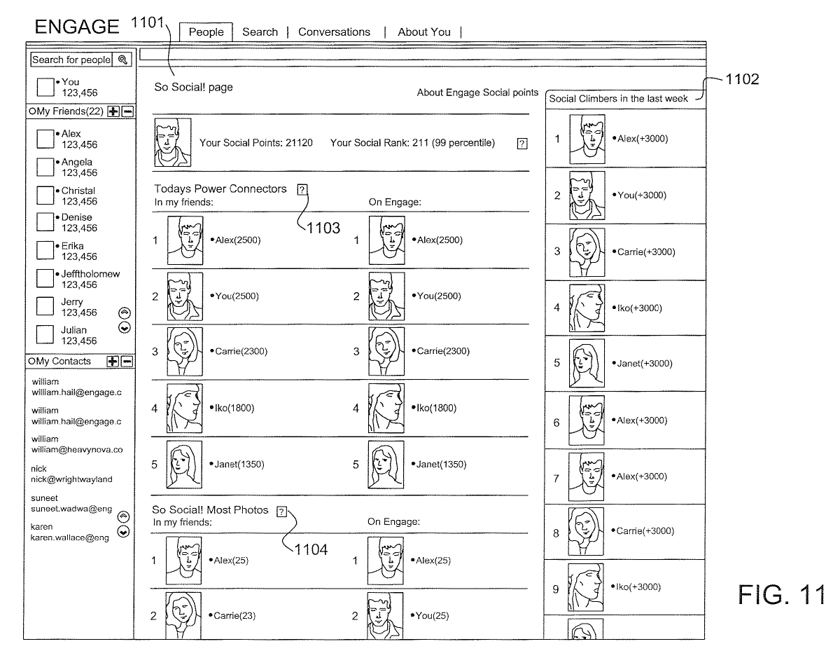

FIG. 11 shows an example of a social scoreboard 1101 in accordance with another aspect of the invention. As explained above, users of the site can accumulate social points for participation in various activities such as voting, making suggestions for matches, and introducing parties to each other. The social scoreboard displays to the user his/her total social points, as well as rank among all members. Additionally, the scoreboard can display a list 1102 of members having gained the most points over a certain recent time period such as the last week, a list 1103 of the current day's points leaders, and a list 1104 of the members having the most posted photos in their profiles. Each of the displayed lists can separately show leaders from among the group of the user's friends, as well leaders from all members of the site.

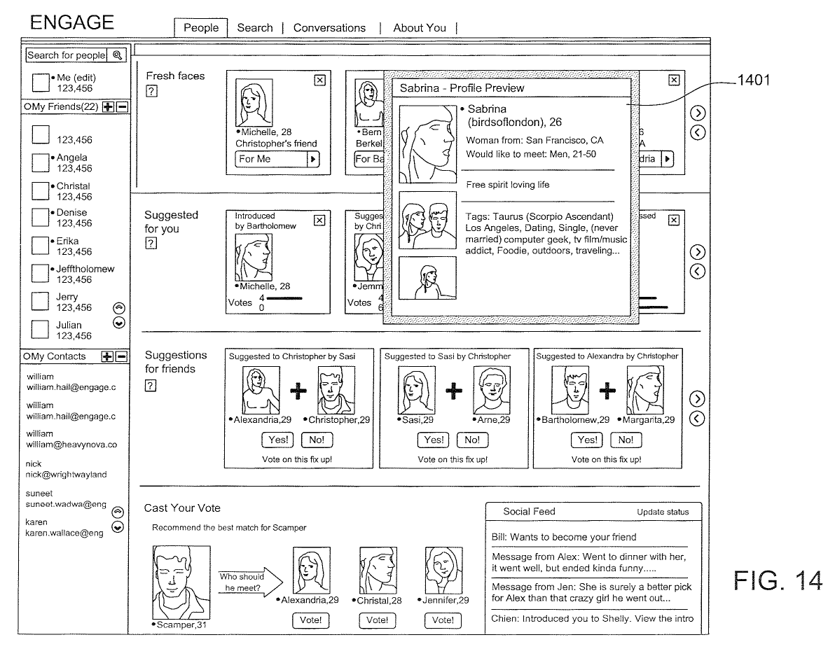

FIG. 12 shows a detailed example of a game module 107 as shown in FIG. 1. A random member profile 1203 is presented to the user together with a number of potential matches 1205. While three potential matches are shown, this number can be greater. The user is asked to vote for one of the potential matches 1205 for member 1203. As shown in FIG. 13, after the user has voted, the user is shown the results 1301 of all voting to date, and can compare the user's selection with the totals. The user also is presented with a new random member profile 1202 and new potential matches on which the user can vote. FIG. 14 illustrates an example of a thumbnail or summary profile 1401, which is displayed whenever a user places a pointer icon over a thumbnail photo of a member. In this manner, member profiles may be viewed quickly, requiring that the user only move his/her pointer over the photo of a member whose profile is desired to be viewed. The user may also click on the photo to view a full profile of the member.

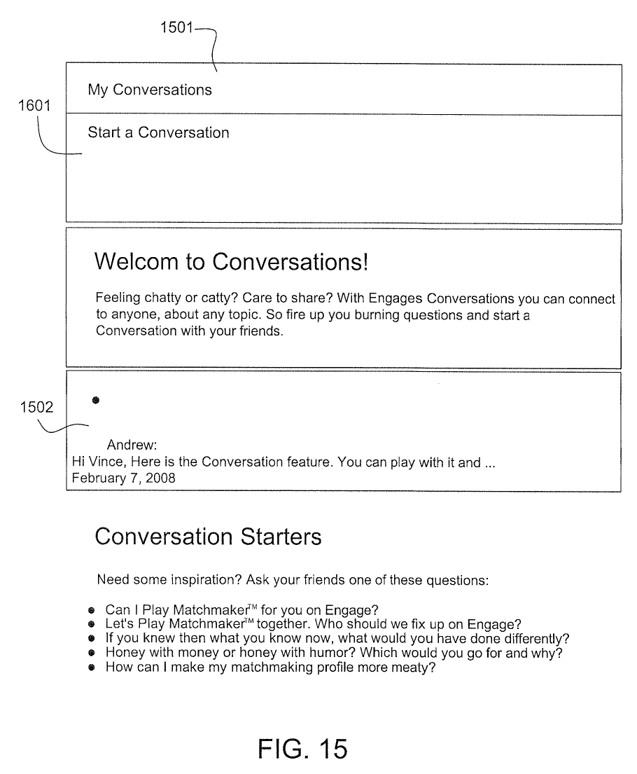

FIGS. 15-17 are directed to a “conversations” feature of the invention. According to this feature, a user may begin a topic of discussion and invite anyone (members or non-members) to participate in the discussion. The user may also attach member profiles to the discussion, which may be viewed or retrieved by the participants with a single click. As shown in FIG. 1, a user may click on a “conversations” tab 112 and be brought to a conversations page as shown in FIG. 15, wherein a user may choose to start a conversation, or review current conversations. The user may click on a “my conversations” tab 1501, which will display the user's current conversations 1502. The user may also click on a “start a conversation” tab 1601 to begin a new conversation.

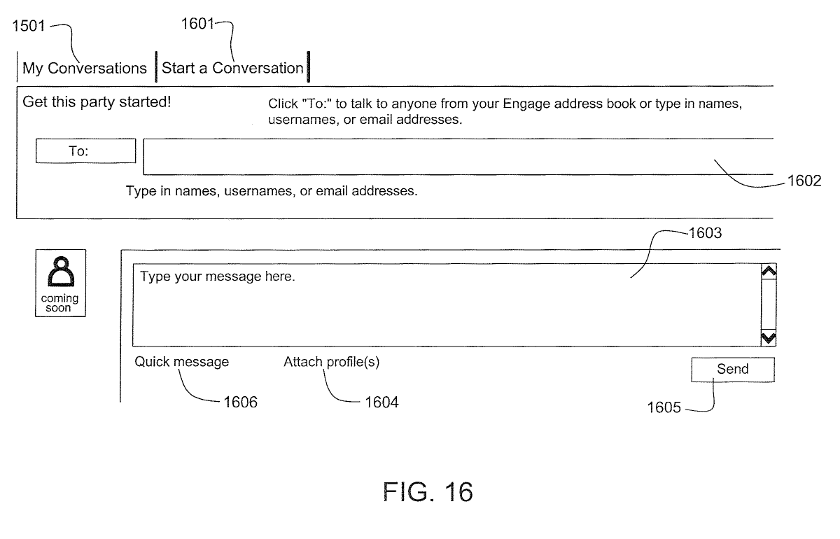

FIG. 16 illustrates an example of a page for starting a new conversation. In box 1602, the user may enter selected invitees by name, username or e-mail address. In box 1603, the user may enter the text of the desired topic of conversation (which may be any topic that the user wishes to discuss, and not limited to matchmaking). If the topic relates to matchmaking, the user may select the profile(s) of the object(s) of discussion by clicking on an “attach profile(s)” tab 1604. Instead of entering text, the user alternatively may select a “quick message” or preselected text by clicking on “quick message” tab 1606. For example, the quick message selections may be short messages such as “you'd be great for my friend” or “check out this profile.” After the user completes data entry, the user clicks on a “send” button 1605. The service will then send notification e-mails to the selected invitees, allowing the invitees to log-in to the site to view the conversation and retrieve any attached profiles, such as by clicking on a hypertext or other link.

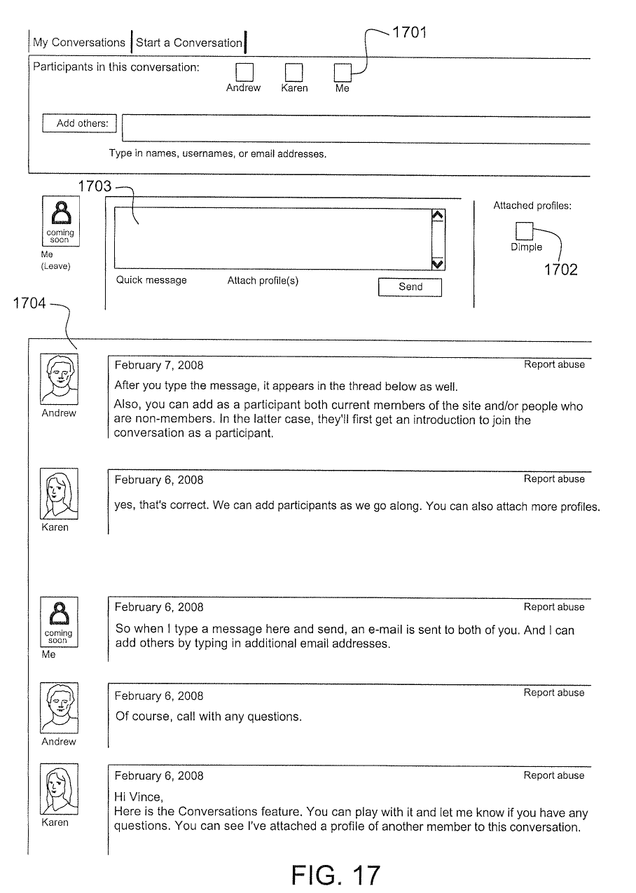

FIG. 17 shows an example of an existing conversation view, which is displayed in response to the user clicking on an existing conversation tab 1502. The existing conversation view shows the participants in the conversation in area 1701, and contains thumbnail views or mini-photo links 1702 to attached profiles to the conversation. The user is able to enter text in entry box 1703 and click a send button to send notifications to the participants of the new message. Prior messages from participants are shown in reverse chronological order in area 1704.

The invention having been thus described, it will be apparent to those skilled in the art that the same may be varied in many ways without departing from the spirit and scope of the invention, which is set forth in the following claims.

What is claimed is:

1. A computer-implemented system for introducing compatible individuals to each other, comprising:
a database storing information pertaining to individuals who are interested in being matched to other individuals;
a computer-executable application that enables a first user to search said database to identify a potentially compatible first individual for a particular second individual;
a computer-executable application that enables said first user to communicate identification of said potentially compatible first individual to a preselected plurality of other users; and
a computer-executable application that enables said first user and plurality of preselected other users to communicate with each other concerning the compatibility of said identified first individual with said second individual in a private environment.

2. The computer-implemented system of claim 1, wherein notifications of new communications in said private environment are sent to said plurality of preselected users through e-mail communication.

3. The computer-implemented system of claim 2, wherein said preselected users review new communications by logging-in to a website.

4. The computer-implemented system of claim 2, wherein said preselected users are members of said website.

5. The computer-implemented system of claim 2, wherein said preselected users are non-members of said website.

6. The computer-implemented system of claim 1, wherein said preselected users review communications in said private environment by logging-in to a website.

7. The computer-implemented system of claim 6, wherein said website presents a personalized page to a logged-in user, containing a display representing a plurality of profiles of selected individuals in said database.

8. The computer-implemented system of claim 7, wherein said display representing a plurality of profiles is divided into categorized profiles according to categories of individuals targeted as potential matches for said profiles.

9. The computer-implemented system of claim 8, wherein said categories include potential matches for predetermined friends of the first user, potential matches for said first user, and preselected new members of said website based on one or more parameters associated with said first user.

10. The computer-implemented system of claim 7, wherein said display further includes paired profiles of suggested individual matches.

11. The computer-implemented system of claim 10, wherein paired profile display further includes a mechanism enabling said first user to vote on said suggested match.

12. The computer-implemented system of claim 7, wherein said display further includes a scrolling mechanism that enables said first user to scroll through multiple pluralities of displayed profiles.

13. The computer-implemented system of claim 7, wherein said display representation comprises thumbnail views of individual profiles, and wherein said display further includes a mechanism that enables said first user to view a detailed profile of each individual by selecting and actuating a thumbnail view.

14. The computer-implemented system of claim 13, wherein actuating a thumbnail profile comprises placing a mouse pointer over said thumbnail view.

15. The computer-implemented system of claim 7, wherein said personalized page includes a social feed identifying events or occurrences of potential interest to the logged-in user.

16. The computer-implemented system of claim 7, further comprising a mechanism enabling said first user to indicate a displayed profile as a match suggestion.

17. The computer-implemented system of claim 1, further comprising an activity-related points system whereby users are awarded a number of points for engaging in predetermined activities, and further including a points ranking display showing points leaders.

18. A computer-implemented system for introducing compatible individuals to each other, comprising:
a database storing information pertaining to individuals who are interested in being matched to other individuals;
a computer-executable application that enables a first user to search said database to identify a potentially compatible first individual for a particular second individual;
a computer-executable application that enables said first user to communicate identification of said potentially compatible first individual to said system as a suggested match; and
a computer-executable application that enables preselected other users to view said suggested match.

19. The computer-implemented system of claim 18, wherein said preselected users view suggested matches by logging-in to a website.

20. The computer-implemented system of claim 19, wherein said preselected users are members of said website.

21. The computer-implemented system of claim 19, wherein said preselected users are non-members of said website.

22. The computer-implemented system of claim 19, wherein said website presents a personalized page to a logged-in user, containing a display representing a plurality of profiles of selected individuals in said database.

23. The computer-implemented system of claim 22, wherein said display representing a plurality of profiles is divided into categorized profiles according to categories of individuals targeted as potential matches for said profiles.

24. The computer-implemented system of claim 23, wherein said categories include potential matches for predetermined friends of the first user, potential matches for said first user, and preselected new members of said website based on one or more parameters associated with said first user.

25. The computer-implemented system of claim 22, wherein said display further includes paired profiles of suggested individual matches.

26. The computer-implemented system of claim 25, wherein paired profile display further includes a mechanism enabling said first user to vote on said suggested match.

27. The computer-implemented system of claim 22, wherein said display further includes a scrolling mechanism that enables said first user to scroll through multiple pluralities of displayed profiles.

28. The computer-implemented system of claim 22, wherein said display representation comprises thumbnail views of individual profiles, and wherein said display further includes a mechanism that enables said first user to view a detailed profile of each individual by selecting and actuating a thumbnail view.

29. The computer-implemented system of claim 28, wherein actuating a thumbnail profile comprises placing a mouse pointer over said thumbnail view.

30. The computer-implemented system of claim 22, wherein said personalized page includes a social feed identifying events or occurrences of potential interest to the logged-in user.

31. The computer-implemented system of claim 22, further comprising a mechanism enabling said first user to indicate a displayed profile as a match suggestion.

32. The computer-implemented system of claim 18, further comprising an activity-related points system whereby users are awarded a number of points for engaging in predetermined activities, and further including a points ranking display showing points leaders.

33. The computer-implemented system of claim 32, further comprising a game module enabling a user to review match suggestions and vote on a suggested match as part of a game, and to accumulate points for participating in said game.

34. The computer-implemented system of claim 17, further comprising a game module enabling a user to review match suggestions and vote on a suggested match as part of a game, and to accumulate points for participating in said game.

35. The computer-implemented system of claim 1, wherein a user can subscribe to said system as a paid member, wherein said subscription entitles said user to designate a predetermined plurality of individuals as members of said system.

36. The computer-implemented system of claim 18, wherein a user can subscribe to said system as a paid member, wherein said subscription entitles said user to designate a predetermined plurality of individuals as members of said system.
